(19) United States
(12) Patent Application Publication
(10) Pub. No.: US 2007/0169980 A1
(43) Pub. Date: Jul. 26, 2007

(54) Transmissionless agricultural vehicle drive system

(75) Inventors: Cecil A. Weeramantry, Darien, IL (US); George Michael Butkovich, Lemont, IL (US)

Correspondence Address: CNH AMERICA LLC;INTELLECTUAL PROPERTY LAW DEPARTMENT, 700 STATE STREET, RACINE, WI, 53404, US

(73) Assignee: CNH America LLC

(21) Appl. No.: 11/337,720

(22) Filed: Jan. 23, 2006

(51) Int. Cl. B60K 17/00

(52) U.S. Cl. 180/307

(57) ABSTRACT

An agricultural vehicle drive system includes at least one variable pump configured to pump a driving fluid. The agricultural vehicle drive system also includes a first set of two-speed motors configured to receive the driving fluid from the at least one variable pump and a first gear system configured to be driven by the first set of two-speed motors to drive at least a first wheel of the agricultural vehicle. The agricultural vehicle drive system further includes a second set of two-speed motors configured to receive the driving fluid from the at least one variable pump, and a second gear system configured to be driven by the second set of two-speed motors to drive at least a second wheel of the agricultural vehicle. Furthermore, each motor in the first set of two-speed motors and the second set of two-speed motors is adjustable between discrete displacement settings to drive the agricultural vehicles at a variety of speed ranges.

### CROSS-REFERENCE TO RELATED APPLICATION

Not applicable.

### STATEMENT REGARDING FEDERALLY SPONSORED RESEARCH OR DEVELOPMENT

Not applicable.

### BACKGROUND OF THE INVENTION

The present invention relates generally to agricultural vehicles and, more particularly, to a system and method for propelling an agricultural vehicle.

Agricultural vehicles such as tractors, harvesters, pickers, and combines are mainstays within the agricultural industry. These large vehicles require specialized propulsion or drive systems to adequately move the agricultural vehicle over the varied terrain that is routinely traversed.

Many agricultural vehicle drive systems employ a hydrostatic drive system. These systems typically include a hydrostatic pump, a fixed speed motor, a multi-speed, generally three or four speed transmission, and a final drive arrangement including differential gears and bull or planetary gears.

Some vehicles, seeking to eliminate the cost and power losses associated with transmission systems, employ a full variable displacement motor engaged with each driving wheel through a multi-stage planetary final drive. However, while these drive systems achieve a full speed range without the necessity of a transmission and, thus are more efficient, the numerous full variable displacement motors add significantly to the manufacturing and product costs as well as the maintenance costs.

### BRIEF SUMMARY OF THE INVENTION

The present invention overcomes the aforementioned drawbacks by providing a transmissionless agricultural propulsion or drive system without the need for full variable displacement motors dedicated to each driving wheel.

In accordance with one aspect of the invention, an agricultural vehicle drive system is disclosed that includes at least one variable pump configured to pump a driving fluid. The agricultural vehicle drive system also includes a first set of two-speed motors configured to receive the driving fluid from the at least one variable pump and a first gear system configured to be driven by the first set of two-speed motors to drive at least a first wheel of the agricultural vehicle. Additionally, the agricultural vehicle drive system includes a second set of two-speed motors configured to receive the driving fluid from the at least one variable pump and a second gear system configured to be driven by the second set of two-speed motors to drive at least a second wheel of the agricultural vehicle. Furthermore, each motor in the first set of two-speed motors and the second set of two-speed motors is adjustable between discrete displacement settings to drive the agricultural vehicles at a variety of speed ranges.

In at least one embodiment, each motor in the first set of two-speed motors and the second set of two-speed motors may be configured to be adjusted between two discrete displacement settings to drive the agricultural vehicle at at least four different speed ranges.

Additionally, according to at least one more embodiment, the driving fluid may be delivered substantially equally to the first set of two-speed motors and the second set of two-speed motors when a directional motion of the agricultural vehicle is along a generally straight path. Similarly, in at least one other embodiment, the driving fluid may be delivered substantially unequally to the first set of two-speed motors and the second set of two-speed motors when a directional motion of the agricultural vehicle substantially deviates from a generally straight path.

Also, according to at least one more embodiment, the first set of two-speed motors and the second set of two-speed motors further may include a variable proportional control device configured to unbalance a torque delivered to wheels on a first side of the agricultural vehicle and wheels on a second side of the agricultural vehicle to provide traction control between the wheels on a first side of the agricultural vehicle and the wheels on a second side of the agricultural vehicle.

Furthermore, in at least one embodiment, at least one variable pump may include a first variable pump configured to primarily pump driving fluid to the first set of two-speed motors and a second variable pump configured to primarily pump driving fluid to the second set of two-speed motors to create a differential lock feature. As such, according to at least one embodiment, the first set of two speed motors and the first gear system may be configured to drive a wheel positioned on a first side of the agricultural vehicle and wherein the second set of two speed motors and the second gear system may be configured to drive a wheel positioned on a second side of the agricultural vehicle. Also, according to at least one additional embodiment, when a directional motion of the agricultural vehicle substantially deviates from a generally straight path, one of the first variable pump and the second variable pump may be configured to increase a pumping speed to achieve a powered turn of the agricultural vehicle in a direction in which the agricultural vehicle substantially deviated from the generally straight path. According to at least one additional embodiment, the first variable pump and the second variable pump may also be configured to adjust a pumping speed to maintain a generally equal driving of at least the first wheel and the second wheel when the agricultural vehicle maintains a substantially straight path.

Additionally, according to at least one embodiment, the first set of two-speed motors may have substantially similar speed ranges as the second set of two-speed motors and may be configured to coordinate switching between substantially similar discrete displacement settings to drive the agricultural vehicle at one of at least four speed ranges.

According to at least one additional embodiment, the first gear system and the second gear system may also include first and second planetary gear systems and first and second input spur gear systems. In this regard, according to at least one additional embodiment, the first planetary gear system and the second planetary gear system may be single stage planetary gear systems.

Additionally, according to at least one additional embodiment, the first set of two-speed motors and the second set of two-speed motors may each include a full variable proportional control motor configured to create a torque unbalance between a first side and a second side of the agricultural vehicle to create a traction control feature.

In accordance with another aspect of the invention, an agricultural vehicle is disclosed that includes at least one variable pump configured to pump a driving fluid. The agricultural vehicle also includes a first side final drive unit having at least first and second, first-side, two-speed motors, each motor configured to receive the driving fluid from the variable pump and a first side gear system configured to be driven by at least one first-side, two-speed motor to drive a first side of the agricultural vehicle. As such, the agricultural vehicle includes a second side final drive unit having at least first and second, second-side, two-speed motors, each motor configured to receive the driving fluid from the variable pump and a second side, gear system configured to be driven by at least one second-side, two-speed motor to drive a second side of the agricultural vehicle. Accordingly, the first and second, first-side, two-speed motors are independently adjustable between speeds and the first and second, second-side, two-speed motors are independently adjustable between speeds to drive the agricultural vehicles at a variety of speed ranges.

Also, according to at least one additional embodiment, the first and second, first-side, two-speed motors and the first and second, second-side, two-speed motors may be adjustable substantially simultaneously between speeds to drive the agricultural vehicle at four different of speed ranges.

Additionally, according to at least one additional embodiment, the agricultural vehicle may be free of a transmission.

Furthermore, according to at least one additional embodiment, the first, first-side, two-speed motor may have substantially similar speed ranges as the first, second-side, two-speed motor and the second, first-side, two-speed motor may have substantially similar speed ranges as the second, second-side, two-speed motor.

In accordance with yet another aspect of the invention, a method of propelling an agricultural vehicle over varying speed ranges is disclosed that includes pumping a driving fluid to a first final drive system configured to drive a first side of the agricultural vehicle and a second final drive system configured to drive a second side of the agricultural vehicle. The method also includes delivering the driving fluid to a first set of two-speed motors configured to drive the first side of the agricultural vehicle, and a second set of two-speed motors configured to drive the second side of the agricultural vehicle. Furthermore, the method includes switching each motor in the first set of two-speed motors and the second set of two-speed motors between speeds to drive the agricultural vehicle at one of at least three distinct speed ranges.

According to at least one additional embodiment, the method may also include pumping the driving fluid to be delivered substantially equally to the first set of two-speed motors and the second set of two-speed motors when a directional motion of the agricultural vehicle is along a generally straight path.

Additionally, according to at least one further embodiment, the method may include controlling a flow of driving fluid shared between the first set of two-speed motors and the second set of two-speed motors to provide one of a differential feature and a differential lock feature.

Various other features of the present invention will be made apparent from the following detailed description and the drawings.

### BRIEF DESCRIPTION OF THE DRAWINGS

Reference is hereby made to the following drawings in which like reference numerals correspond to like elements throughout, and in which:

FIG. 1 is a perspective view of an agricultural vehicle having a drive system in accordance with the present invention;

FIG. 2 is a schematic overview of one embodiment of an agricultural vehicle drive system in accordance with the present invention; and

FIG. 3 is a schematic overview of another embodiment of an agricultural vehicle drive system in accordance with the present invention.

### DETAILED DESCRIPTION

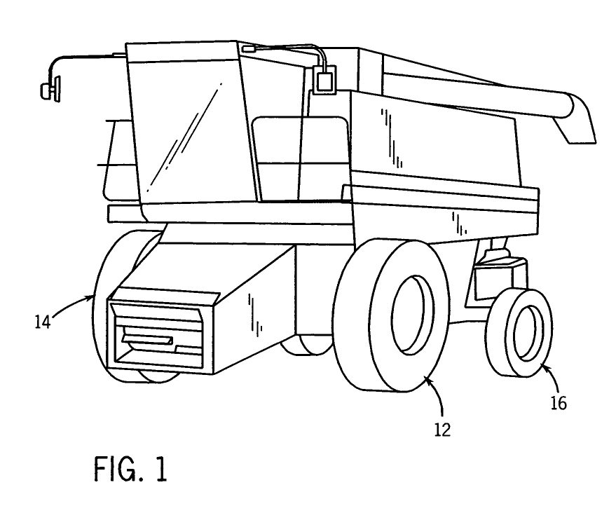

Referring to FIG. 1, an agricultural vehicle 10 is shown. While agricultural vehicle 10 is shown as a combine harvester, it is contemplated that the present invention may be used with a wide variety of self-propelled agricultural vehicles including pickers, sprayers, and the like. Agricultural vehicle 10 includes a front right-hand wheel 12 and a front left-hand wheel 14 that, as shown are driven by the primary propulsion system, whereas a rear left-hand wheel 16 and a rear right-hand wheel (not shown) serve as part of the steering system. Alternatively, it is contemplated that the roles of the wheels may be reversed, such that the front wheels 12, 14 serve as the steering system and the rear wheels 16 serve as the propulsion system. In either case, as will be described, the wheels serving as the primary propulsion system are coupled to a drive system that causes the wheels to rotate and propel agricultural vehicle 10 in a desired direction.

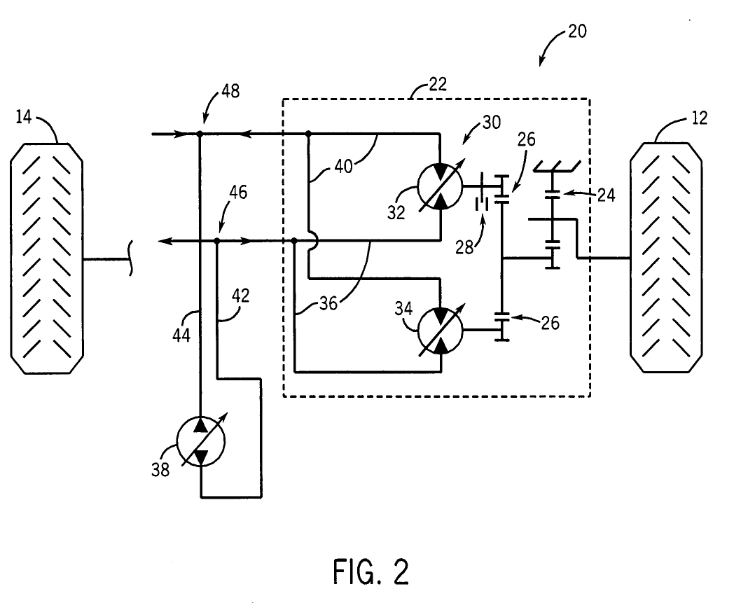

Referring now to FIG. 2, a drive system 20 is shown. In particular, only a right-hand side final drive unit 22 is shown as coupled to front right-hand wheel 12. That is, a left-hand final drive unit, which is coupled to front left-hand wheel 16 and is identical to right-hand final drive unit 22 is not shown in the interest of simplifying the explanation. Wheel 12 is coupled through a planetary gear coupling 24, input spur gears 26, and a brake 28 to a set of two, two-speed motors generally designated 30 and individually identified 32, 34. That is, two individual two-speed motors, or two motors each having two discrete displacement settings, are included in right-hand side final drive unit 22.

By using at least two motors in a given motor set, the given motor set can achieve at least approximately 20 percent higher speeds than a single motor of equivalent capacity. Similarly, using a set of motors instead of a single motor can be more volumetrically efficient and cost effective while achieving an overall size reduction.

Planetary gear coupling 24 preferably includes a single stage simple planetary unit driven by spur gear drive 26, which is, in turn, powered by the two, two-speed motors 32, 34. In this regard, a two stage planetary gear coupling is not required, which simplifies the overall design of final drive 22.

Motor set 30 is supplied with driving fluid via a set of supply lines 36. That is, the two, two-speed motors are supplied with driving fluid from a variable displacement pump 38 via supply lines 36. Diving fluid is returned to variable displacement pump 38 via return lines 40.

As two-speed motors, each motor 32, 34 has two displacement settings, which, in accordance with one embodiment, may differ between motors 32, 34, to achieve a full set of speed ranges. For example, it is contemplated that one motor 32 may be an 80 cc per revolution (cc/rev) motor and the other motor 34 may be a 160 cc/rev. Accordingly, each motor 32, 34 has two distinct speed ranges that can be combined to form a full set of speed ranges at which to drive the wheel 12 and thereby propel the agricultural vehicle 10 of FIG. 1. More generally, two-speed motor 32 has a first speed setting S1 and a second speed setting S2, and two-speed motor 34 has a first speed setting S3 and a second speed setting S4. According to one embodiment, as a result of differing displacement sizes (e.g. 80 cc/rev and 160 cc/rev), the speed settings of two-speed motor 32 are not the same as the speed settings of two-speed motor 34. In this regard, four distinct ranges are achieved by combining the speed settings of the set of two, two-speed motors 30. In particular, the speed ranges are achieved according to the following combinations: S1, S3; S1, S4; S2, S3; S2, S4.

Alternatively, it is contemplated that the two-speed motors 32, 34 may have matching sizes. In this case, four distinct settings could be used to achieve these four speed ranges. In any case, the motor settings are generally adjusted in unison. That is, the switching between speed ranges (i.e. from S1, S3 to S1, S4) occurs substantially simultaneously by both the right and left side drive system such that the drive systems on both sides will have the same speed settings.

In operation, driving or hydraulic fluid is delivered down a primary supply line 42 to the secondary supply lines 36 and returned to the variable displacement pump 38 via the secondary return lines 40 and a primary return line 44. As shown in FIG. 2, the single displacement pump 38 supplies driving fluid to both final drive sides of the agricultural vehicle, as indicated by a supply T-joint 46 and a return T-joint 48. Accordingly, it is contemplated that during generally straight directional traveling of the agricultural vehicle, the flow of driving fluid along primary supply 42 is substantially equally split to right-hand side final drive 22 and left-hand side final drive (not shown). On the other hand, during a turn by the agricultural vehicle, it is contemplated that an unequal flow of driving fluid may be split from the primary supply line 44 between right-hand side final drive 22 and left-hand side final drive (not shown) to provide differential action. In particular, an unequal flow is created between right-hand side final drive 22 and left-hand side final drive (not shown) that is caused by differential action between the drive units. However, actual turning is achieved via conventional steering of the non-driving wheels.

In this invention, the two motors on the left side and the two motors on the right side normally would operate at identical settings.

In this regard, if a differential lock is desired by the driver of the agricultural vehicle, it is contemplated that a traction control feature can be provided by replacing one of the two-speed motors 32, 34 with a full variable proportional control motor in order to create a torque unbalance between the right-hand and left-hand sides of the agricultural vehicle. In this regard, motor set 30 provides a wide variety of design flexibility. That is, by using unequal motors and/or gear ratios, a wide variety of design requirements can be met.

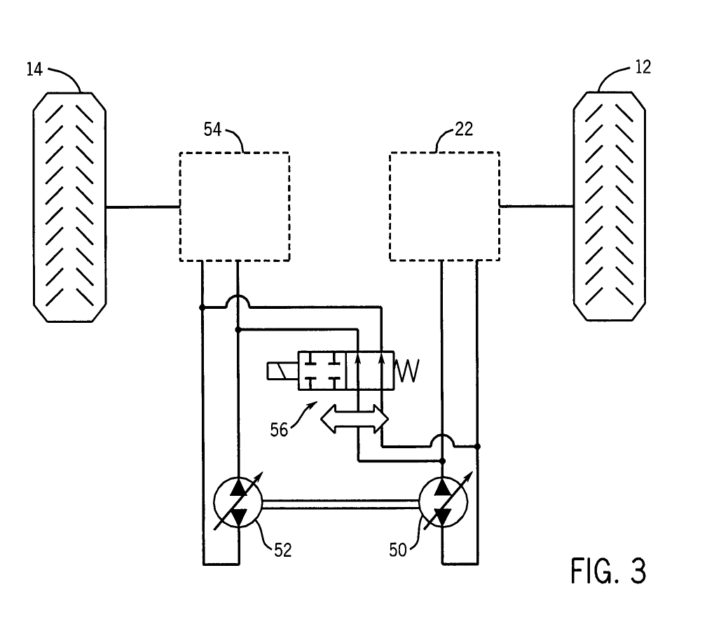

Referring now to FIG. 3, the single variable displacement pump 38 of FIG. 2 has been replaced with two variable displacement pumps 50, 52. Specifically, a first variable displacement pump 50 supplies driving fluid to right-hand final drive 22 and a second variable displacement pump 52 supplies driving fluid to a left-hand final drive 54. More particularly, first variable displacement pump 50 supplies driving fluid to right-hand final drive 22 independently from second variable displacement pump 52 supplying driving fluid to a left-hand final drive 54, and vice versa. As such, the size of the individual variable displacement pumps 50, 52 can be reduced with respect to the single variable displacement pump 38 of FIG. 2.

Additionally, it is contemplated that a valve controlled cross-over system 56 may be included. When valve system 56 is in an open position, as shown, a conventional differential action is provided. However, if valve system 56 is switched to a closed position, the flow of driving fluid between the two variable displacement pumps 50, 52 is cut off and a differential lock feature is created. Furthermore, when valve system 56 is closed, pumps 50, 52 can be independently driven to provide powered turning of the agricultural vehicle. It is also contemplated that a bleed circuit (not shown) may be included to provide a full differential feature.

Therefore, the present invention provides a hydrostatic agricultural vehicle propulsion system that utilizes a variable pump driving at least two, two-speed motors located at each driving wheel. The two motors operate at each wheel in a substantially parallel fashion. The driving wheels are connected to the twin motor unit or motor set via a planetary reduction gear box. By advantageously pairing the two-speed motors, a full speed range can be achieved without the need for ratio changing mechanical transmissions. That is, each motor has two displacement settings that can be combined to form four combinations of settings. These combinations effectively achieve similar speed ranges as a four speed mechanical transmission. Specifically, the propulsion system can cover the entire propulsion speed and torque regime achieved by a drive system employing a mechanical transmission or variable displacement motors, without the costs and inefficiencies associated with such systems.

Additionally, hydraulic interconnections between the motors and any valves associated with such connections are not required. However, such interconnections can be provided to provide a differential lock and/or traction control features.

Accordingly, the above-described system provides a final drive system for an agricultural vehicle that includes a set of two-speed motors to create a transmissionless propulsion system that is more cost effective and efficient than systems employing fully variable speed motors. Additionally, the use of a set of at least two, two-speed motors dedicated to each driving wheel facilitates the use of an increased final drive ratio yielding increased output torque. Similarly, gear tooth and bearing loads can be reduced.

As such, one embodiment of the invention includes an agricultural vehicle drive system. The agricultural vehicle drive system includes at least one variable pump configured to pump a driving fluid. The agricultural vehicle drive system also includes a first set of two-speed motors configured to receive the driving fluid from the at least one variable pump, and a first gear system configured to be driven by the first set of two-speed motors to drive at least a first wheel of the agricultural vehicle. Additionally, the agricultural vehicle drive system includes a second set of two-speed motors configured to receive the driving fluid from the at least one variable pump and a second gear system configured to be driven by the second set of two-speed motors to drive at least a second wheel of the agricultural vehicle. Furthermore, each motor in the first set of two-speed motors and the second set of two-speed motors is adjustable between discrete displacement settings to drive the agricultural vehicles at a variety of speed ranges.

Another embodiment of the invention includes an agricultural vehicle having at least one variable pump configured to pump a driving fluid. The agricultural vehicle also includes a first side final drive unit having at least first and second, first-side, two-speed motors, each motor configured to receive the driving fluid from the variable pump and a first side gear system configured to be driven by at least one first-side, two-speed motor to drive a first side of the agricultural vehicle. As such, the agricultural vehicle includes a second side final drive unit having at least first and second, second-side, two-speed motors, each motor configured to receive the driving fluid from the variable pump and a second side gear system configured to be driven by at least one second-side, two-speed motor to drive a second side of the agricultural vehicle. Accordingly, the first and second, first-side, two-speed motors are independently adjustable between speeds and the first and second, second-side, two-speed motors are independently adjustable between speeds to drive the agricultural vehicle at a variety of speed ranges.

A further embodiment of the invention includes a method of propelling an agricultural vehicle over varying speed ranges. The method includes pumping a driving fluid to a first final drive system configured to drive a first side of the agricultural vehicle and a second final drive system configured to drive a second side of the agricultural vehicle. The method also includes delivering the driving fluid to a first set of two-speed motors configured to drive the first side of the agricultural vehicle and a second set of two-speed motors configured to drive the second side of the agricultural vehicle. Furthermore, the method includes switching each motor in the first set of two-speed motors and the second set of two-speed motors between speeds to drive the agricultural vehicle at one of at least three distinct speed ranges.

The present invention has been described in terms of the preferred embodiment, and it should be appreciated that many equivalents, alternatives, variations, and modifications, aside from those expressly stated, are possible and within the scope of the invention. Therefore, the invention should not be limited to a particular described embodiment.

We claim:

1. An agricultural vehicle drive system comprising:
at least one variable pump configured to pump a driving fluid;
a first set of two-speed motors configured to receive the driving fluid from the at least one variable pump;
a first gear system configured to be driven by the first set of two-speed motors to drive at least a first wheel of the agricultural vehicle;
a second set of two-speed motors configured to receive the driving fluid from the at least one variable pump;
a second gear system configured to be driven by the second set of two-speed motors to drive at least a second wheel of the agricultural vehicle; and
wherein each motor in the first set of two-speed motors and the second set of two-speed motors is adjustable between discrete displacement settings to drive the agricultural vehicle at a variety of speed ranges.

2. The agricultural vehicle drive system of claim 1 wherein each motor in the first set of two-speed motors and the second set of two-speed motors are configured to be adjusted between two discrete displacement settings to drive the agricultural vehicle at at least four different speed ranges.

3. The agricultural vehicle drive system of claim 1 wherein the driving fluid is delivered substantially equally to the first set of two-speed motors and the second set of two-speed motors when a directional motion of the agricultural vehicle is along a generally straight path.

4. The agricultural vehicle drive system of claim 1 wherein the driving fluid is delivered substantially unequally to the first set of two-speed motors and the second set of two-speed motors when a directional motion of the agricultural vehicle substantially deviates from a generally straight path.

5. The agricultural vehicle drive system of claim 1 wherein the first set of two-speed motors and the second set of two-speed motors further include a variable proportional control device configured to unbalance a torque delivered to wheels on a first side of the agricultural vehicle and wheels on a second side of the agricultural vehicle to provide traction control between the wheels on a first side of the agricultural vehicle and the wheels on a second side of the agricultural vehicle.

6. The agricultural vehicle drive system of claim 1 wherein the at least one variable pump includes a first variable pump configured to primarily pump driving fluid to the first set of two-speed motors and a second variable pump configured to primarily pump driving fluid to the second set of two-speed motors to create a differential lock feature.

7. The agricultural vehicle drive system of claim 6 wherein the first set of two speed motors and the first gear system are configured to drive a wheel positioned on a first side of the agricultural vehicle and wherein the second set of two speed motors and the second gear system are configured to drive a wheel positioned on a second side of the agricultural vehicle.

8. The agricultural vehicle drive system of claim 7 wherein, when a directional motion of the agricultural vehicle substantially deviates from a generally straight path, one of the first variable pump and the second variable pump is configured to increase a pumping speed to achieve a powered turn of the agricultural vehicle in a direction in which the agricultural vehicle substantially deviated from the generally straight path.

9. The agricultural vehicle drive system of claim 7 wherein the first variable pump and the second variable pump are configured to adjust a pumping speed to maintain a generally equal driving of at least the first wheel and the second wheel when the agricultural vehicle maintains a substantially straight path.

10. The agricultural vehicle drive system of claim 1 wherein the first set of two-speed motors have substantially similar speed ranges as the second set of two-speed motors and are configured to coordinate switching between substantially similar discrete displacement settings to drive the agricultural vehicles at one of at least four speed ranges.

11. The agricultural vehicle drive system of claim 1 wherein the first gear system and the second gear system include first and second planetary gear systems and first and second input spur gear systems.

12. The agricultural vehicle drive system of claim 11 wherein the first planetary gear system and the second planetary gear system are single stage planetary gear systems.

13. The agricultural vehicle drive system of claim 1 wherein the first set of two-speed motors and the second set of two-speed motors each include a full variable proportional control motor configured to create a torque unbalance between a first side and second side of the agricultural vehicle to create a traction control feature.

14. An agricultural vehicle comprising:
at least one variable pump configured to pump a driving fluid;
a first side final drive unit comprising:
at least first and second, first-side, two-speed motors, each motor configured to receive the driving fluid from the variable pump;
a first side gear system configured to be driven by at least one first-side, two-speed motor to drive a first side of the agricultural vehicle;
a second side final drive unit comprising:
at least first and second, second-side, two-speed motors, each motor configured to receive the driving fluid from the variable pump;
a second side gear system configured to be driven by at least one second-side, two-speed motor to drive a second side of the agricultural vehicle; and
wherein the first and second, first-side, two-speed motors are independently adjustable between speeds and the first and second, second-side, two-speed motors are independently adjustable between speeds to drive the agricultural vehicle at a variety of speed ranges.

15. The agricultural vehicle of claim 14 wherein the first and second, first-side, two-speed motors and the first and second, second-side, two-speed motors are adjustable substantially simultaneously between speeds to drive the agricultural vehicle at four different speed ranges.

16. The agricultural vehicle of claim 14 wherein the agricultural vehicle is free of a transmission system.

17. The agricultural vehicle of claim 14 wherein the first, first-side, two-speed motor has substantially similar speed ranges as the first, second-side, two-speed motor and the second, first-side, two-speed motor has substantially similar speed ranges as the second, second-side, two-speed motor.

18. A method of propelling an agricultural vehicle over varying speed ranges, the method comprising:
pumping a driving fluid to a first final drive system configured to drive a first side of the agricultural vehicle and a second final drive system configured to drive a second side of the agricultural vehicle;
delivering the driving fluid to a first set of two-speed motors configured to drive the first side of the agricultural vehicle and a second set of two-speed motors configured to drive the second side of the agricultural vehicle;
switching each motor in the first set of two-speed motors and the second set of two-speed motors between speeds to drive the agricultural vehicle at one of at least three distinct speed ranges.

19. The method of claim 18 further comprising pumping the driving fluid to be delivered substantially equally to the first set of two-speed motors and the second set of two-speed motors when a directional motion of the agricultural vehicle is along a generally straight path.

20. The method of claim 18 further comprising controlling a flow of driving fluid shared between the first set of two-speed motors and the second set of two-speed motors to provide one of a differential feature and a differential lock feature.
